(19) United States
(12) Patent Application Publication
(10) Pub. No.: US 2022/0161372 A1
(43) Pub. Date: May 26, 2022

(54) Method of Manufacturing a Brazing Sheet Product

(71) Applicant: Aleris Rolled Products Germany GmbH, Koblenz (DE)

(72) Inventors: Steven Kirkham, Ransbach-Baumbach (DE); Bernd Jacoby, Limburg (DE)

(73) Assignee: Aleris Rolled Products Germany GmbH, Koblenz (DE)

(21) Appl. No.: 17/310,194

(22) PCT Filed: Jan. 21, 2020
(86) PCT No.: PCT/EP2020/051363

§ 371 Date: Jul. 26, 2021

(30) Foreign Application Priority Data
Jan. 31, 2019 (EP) 19154779.3

(51) Int. Cl. B23K 35/28; B23K 1/00; B23K 1/19; B21B 1/38; C22C 21/08

(52) U.S. Cl. CPC B23K 35/288; B23K 1/0012; B23K 2101/14; B21B 1/38; C22C 21/08; B23K 1/19

(57) ABSTRACT

The invention relates to a method of manufacturing a brazing sheet product having a core layer of a 3xxx-series aluminium alloy clad on one or both sides with a 4xxx-series aluminium alloy brazing layer, the method comprising the steps of: (i) casting a rolling ingot of the core layer of a 3xxx-series aluminium alloy having the following composition, in wt. %: Mn 0.5-1.8, Si≤1.5, Fe≤0.7, Cu≤1.5, Mg≤1.0, Cr≤0.25, Zr≤0.25, Ti≤0.25, Zn≤0.5, balance impurities and aluminium; (ii) hot rolling of the rolling ingot to a hot rolled sheet having thickness of 2.5-10 mm; (iii) cold rolling of the hot rolled sheet to a gauge of 0.1-4 mm, optionally with an intermediate annealing step during the cold rolling operation; (iv) soft annealing to recrystallize the microstructure of the aluminium sheet, preferably at a temperature in the range of 250° C.-450° C.; (v) further cold rolling of the soft annealed sheet with a cold rolling reduction in the range of 5% to <10% to a final cold rolling thickness; and (vi) recovery annealing at 200° C.-420° C. of the cold rolled aluminium sheet at final cold rolling thickness.

### FIELD OF THE INVENTION

The invention relates to a method of manufacturing a brazing sheet product suitable for manufacturing a heat exchanger, the brazing sheet product having a core layer of a 3xxx-series aluminium alloy clad on one or both sides with a 4xxx-series brazing layer. The brazing sheet product offers enhanced resistance against liquid film migration.

### BACKGROUND OF THE INVENTION

In the manufacturing of light brazed heat exchanger assemblies utilizing aluminium brazing sheet products and commercial braze processes the industry standard has trended to lower sheet thicknesses, requiring improved product performance characteristics such as formability, brazeability, strength and corrosion resistance.

Liquid Film Migration (“LFM”), also known as liquid core penetration or core penetration, is a known but persistent problem in the use of aluminium alloy brazing sheet products when manufacturing brazed devices like heat exchangers. During the brazing cycle of an assembly of components forming together a heat exchanger apparatus the molten AlSi filler alloy penetrates the solid aluminium alloy core alloy along the sub-grain boundaries resulting in decreased brazeability with accompanying increase in eroded area and overall poor performance characteristics.

It is known that the sensitivity of a material to core penetration depth is relatively low in the fully annealed (O-temper) product, especially if the same full annealed product is used in a “slightly cold worked” condition. By the term “slight cold worked” conditions, we refer to the deformation resulting from an industrial process such as stamping which are typically applied to produce heat exchangers components such as evaporator or oil cooler core plates, folded tubes, and heat transfer fins. When a brazing sheet material is produced in the full annealed condition consisting of a core alloy and an Al—Si brazing alloy (one or two side clad) is deformed to form a product and subsequently subjected to a brazing cycle, the “slight cold work” appears to be sufficient to induce core penetration in the brazing sheet product.

It is known in the art that the LFM prevention is significantly enhanced by the use of an aluminium alloy interlayer positioned between the core and the clad AlSi filler layer and that will only recrystallize early in the brazing cycle, thereby preventing liquid brazing alloy coming into contact with the core alloy.

For example European patent EP-2877317-B1 discloses a brazing sheet product having an aluminium core and an interlayer of a defined 3xxx-series aluminium alloy composition located between the aluminium core and the Al—Si brazing clad layer, and wherein the interlayer exhibits in the post-braze condition a volume fraction of a texture component of at least 30%, preferably a P-texture {110}<111> component. This patent document further discloses a method of manufacturing such brazing sheet product comprising the steps of hot rolling, cold rolling of the strip such that the interlayer is reduced by at least 90% in thickness, and the whole strip is then heat-treated to soften the material but without any recrystallization of the interlayer. This patent document is aiming at a known underlying metallurgical mechanism whereby in the pre-braze condition at least the interlayer has an unrecrystallised microstructure that will recrystallize during the brazing cycle thereby forming large grains and only a few (sub)-grain boundaries to provide an increased resistance to LFM.

Patent document EP-2243589-A1 discloses an aluminium alloy clad sheet that is used to form a refrigerant passage of a heat exchanger, the aluminium alloy clad sheet comprising a core material, a cladding material 1, and a cladding material 2, one side and the other side of the core material being respectively clad with the cladding material 1 and the cladding material 2, the core material comprising (in wt. %) 0.5-1.2% of Si, 0.2-1.0% of Cu, and 1.0-1.8% of Mn, with the balance being Al and unavoidable impurities, the cladding material 1 comprising 3-6% of Si, 2-8% of Zn, and at least one of 0.3-1.8% of Mn and 0.05-0.3% of Ti, with the balance being Al and unavoidable impurities, and the cladding material 2 comprising 6-13% of Si, with the balance being Al and unavoidable impurities, the cladding material 1 being positioned opposite to the refrigerant passage during use. Also a method is disclosed of producing the aluminium alloy clad sheet, the method comprising: homogenizing an ingot of an aluminium alloy that forms the core material at 550-620° C. for 2-20 hours; cladding the ingot with an aluminium alloy that forms the cladding material 1 and an aluminium alloy that forms the cladding material 2; hot-rolling the resulting product; cold-rolling the hot-rolled product, the hot-rolled product being heated at 300-400° C. for 2-5 hours during the cold-rolling so that the core material has a recrystallized structure; cold-rolling the resulting product to a final thickness at a rolling reduction rate of 10-40%; and subjecting the resulting product to a recovery treatment by heating the product at 200-450° C. for 2-5 hours.

Patent document EP-1918394-A2 discloses a sagging resistant strip alloy, in particular a fin material, produced by (a) casting, preferably by means of twin-roll casting, a melt comprising (in wt. %): 0.3-1.5% Si, ≤0.5% Fe, ≤0.3% Cu, 1.0-2.0% Mn, ≤0.5% Mg, ≤4.0% Zn, ≤0.5% Ni, ≤0.3% each of dispersoid forming elements from group IVb, Vb, or Vlb, and unavoidable impurity elements, each at most 0.05%, in a total amount of at most 0.15%, the rest aluminium, so as to obtain an ingot, (b) preheating the ingot at a temperature of less than 550° C., preferably 400-520° C., so as to form dispersoid particles, (c) hot rolling to obtain a strip, (d) cold rolling the strip obtained in step c) with a total reduction of at least 90%, preferably >95% resulting in a strip having a first proof stress value, (e) followed by a heat treatment to the delivery temper with the purpose to soften the material by a tempering without any recrystallisation of the strip alloy, in such a way that a strip is obtained having a second proof stress value which is 10-50% lower than the first proof stress value (obtained directly after cold rolling in step (d), preferably 15-40% lower, and lying in the 0.2% proof stress range of 100-200 MPa, more preferably 120-180 MPa, most preferably 140-180 MPa.

Patent document WO-2007/131727-A1 discloses a method for producing a scrap absorbing clad aluminium alloy sheet for brazing purposes including: (a) casting core alloy ingot from a charge produced using an amount of brazing sheet scrap, the core alloy including, in wt. %: Fe 0.06-0.6%, Si 0.4-1.3%, Cu 0.1-1.2%, Mg≤0.25%, Mn 0.5-1.5%, Zn≤0.25%, Ti≤0.2%, Cr 0.05-0.2%, Zr≤0.2%, optionally Sn<0.25%, V<0.25%, In<0.20%, other elements ≤0.05% each and ≤0.15% total, balance aluminum; (b) cladding the core alloy with Al—Si alloy on at least one side with a clad ratio of 3-25%; (c) preheating the cladded core alloy to 400° C. to 530° C. for 1 to 25 hours prior to hot rolling; (d) hot rolling; (e) cold rolling to final thickness. The amount of brazing sheet scrap is at least 25% in weight of the total metal added to prepare the charge. The sheet including chromium containing (Al,Fe,Mn) and (Al,Fe,Mn,Si) intermetallics. No reference is made to LFM resistance.

### DESCRIPTION OF THE INVENTION

As will be appreciated herein below, except as otherwise indicated, aluminium alloy and temper designations refer to the Aluminium Association designations in Aluminum Standards and Data and the Registration Records, as published by the Aluminium Association in 2018 and are well known to the persons skilled in the art.

For any description of alloy compositions or preferred alloy compositions, all references to percentages are by weight percent unless otherwise indicated.

The term “up to” and “up to about”, as employed herein, explicitly includes, but is not limited to, the possibility of zero weight-percent of the particular alloying component to which it refers. For example, up to 0.25% Zn may include an alloy having no Zn.

It is an object of the invention to provide a method of manufacturing an aluminium alloy brazing sheet product having an increased resistance against LFM.

This and other objects and further advantages are met or exceeded by the present invention providing a method of manufacturing a brazing sheet product suitable for manufacturing a heat exchanger, the brazing sheet product having a core layer of a 3xxx-series aluminium alloy clad on one or both sides with a 4xxx-series aluminium alloy brazing layer, the method comprising the steps of, in that order:

(a) casting, for example by means of direct-chill casting, a rolling ingot of the core layer of a 3xxx-series aluminium alloy having the following composition, in wt. %:

| | |
|---|---|
| Mn | 0.5 to 1.8, |
| Si | up to 1.2, |
| Fe | up to 0.7, |
| Cu | up to 1.5, |
| Mg | up to 1.0, |
| Cr | up to 0.25, |
| Zr | up to 0.25, |
| Ti | up to 0.25, |
| Zn | up to 0.5, |

other elements and impurities each <0.05, total <0.15, balance aluminium.

(b) hot rolling of the rolling ingot to a hot rolled sheet having thickness of 2.5 to 10 mm; prior to hot rolling the ingot has been pre-heated to hot rolling entry temperature. Optionally the ingot has been homogenised at a temperature in a range of 550° C. to 630° C. for at least 1 hour, preferably for at least 4 hours, followed by cooling to hot rolling entry temperature or by cooling to ambient temperature and reheating to hot rolling entry temperature.
(c) cold rolling of the hot rolled sheet to a gauge of 0.1 to 4 mm, optionally with one or more intermediate annealing step(s) during the cold rolling operation, the intermediate annealing step(s) is preferably at a temperature range of 200° C. to 450° C.;
(d) soft annealing to recrystallize the microstructure of the aluminium sheet forming the core layer; preferably at a temperature in the range of 250° C. to 450° C., more preferably in a temperature range of 300° C. to 400° C., and more preferably in a temperature range of 350° C. to 420° C.;
(e) further cold rolling of the soft annealed sheet such that the aluminium core alloy receives a cold rolling reduction in the range of 5% to <10%, and preferably 5% to 9%, more preferably 6% to 9%, and most preferably 6% to 8%, to a final cold rolling thickness, preferably in a range of 0.1 mm to 3 mm, and more preferably of 0.2 mm to 2.5 mm;
(f) final recovery annealing of the cold rolled aluminium sheet at final cold rolling thickness. The final recovery annealing is performed at a temperature between 200° C. and 420° C., preferably between 200° C. and 400° C., and more preferably between 250° C. to 380° C., and most preferably between 250° C. and 320° C., for a period of up to about 7 hours, such that the aluminium sheet forming the core layer is substantially not further recrystallized, whereas the elongation (A50 in the L-direction) is increased to values of more than 10%, preferably of more than 12%, and more preferably of more than 14%.

Thereafter the final recovery annealed sheet material is coiled and stored for shipment. Optionally, as in known in the art, the final recovery annealed sheet material is very lightly stretched or levelled (leading to a stretching of less than about 0.5%) to increase sheet product flatness and remove residual stresses prior to slitting to final width.

It has been found that the combination of cold rolling to a degree of only 5% to <10% of the soft annealed core layer in combination with the subsequent final recovery annealing results in a brazing sheet product which has not only improved formability depending on the time and temperature of the final recovery annealing step, but also a significantly reduced susceptibility to LFM and thereby providing the associated improvements in braze performance, strength and corrosion resistance.

The 3xxx-series aluminium core alloy manufactured in accordance with the invention has a composition, in wt. %:

| | |
|---|---|
| Mn | 0.5 to 1.8, preferably 0.6 to 1.5, more preferably 0.6 to 1.25, |
| Si | up to 1.2, preferably ≤0.9, more preferably ≤0.5, |
| Fe | up to 0.7, preferably ≤0.5, |
| Cu | up to 1.5, preferably ≤1.2, more preferably 0.20-1.2 or ≤0.25, |
| Mg | up to 1.0, preferably ≤0.7, more preferably 0.10-0.7 or ≤0.15, |
| Cr | up to 0.25, preferably ≤0.15, |
| Zr | up to 0.25, preferably ≤0.15, |
| Ti | up to 0.25, preferably ≤0.2, more preferably 0.005 to 0.20, |
| Zn | up to 0.5, preferably ≤0.25, |

other elements and impurities each <0.05, total <0.15, and balance aluminium.

This aluminium alloy composition allows a high pre-braze formability, a high post-braze strength and high post-braze corrosion resistance, in particular having a SWAAT-test result of more than 30 days and in the best examples of more than 40 days, and having a high resistance to LFM.

In an embodiment, the aluminium core alloy has a composition consisting of, in wt. %: Mn 0.5-1.8, Si up to 1.2, Fe up to 0.7, Cu up to 1.5, Mg up to 1.0, Cr up to 0.25, Zr up to 0.25, Ti up to 0.25, Zn up to 0.5, other elements and impurities each <0.05, total <0.15; balance aluminium, and with preferred ranges as herein described and claimed.

The brazing sheet product manufactured in accordance with the invention is clad on one or both sides with a with a 4xxx-series aluminium alloy brazing layer. In an embodiment each brazing layer has a thickness of 4% to 20%, preferably 5% to 15% of the total brazing sheet thickness. In the embodiment where the core layer is clad on only one side with a brazing layer or filler alloy layer, the other side can be clad, if so required, with a layer providing enhanced corrosion protection to the core layer.

The 4xxx-series aluminium brazing alloys have Si in a range of 4% to 14% as its main alloying constituent. Typical commercially available filler alloys within this series are AA4343, AA4045, AA4047, AA4147, AA4004, AA4104, or some near compositional variants thereof. The 4xxx-series aluminium alloy may further contain one or more elements selected (in particular Zn, In, and/or Sn) in a concentration tailored to effect a desired electrochemical potential within and adjacent to a brazing joint or fillet. Typically, the purposive addition of Zn is up to about 5%.

In an embodiment the 4xxx-series aluminium alloy brazing layer further contains one or more wetting elements, or elements modifying the surface tension of a molten Al—Si filler material to facilitate a brazing operation. Preferably the elements are selected from the group comprising Bi, Y, Pb, Li, Na, Sb, Sr, and Th, and wherein the total amount of the wetting element(s) is in a range of about 0.01% to 0.8%. In a preferred embodiment the upper-limit for the total amount of wetting element(s) is 0.4%.

For the brazing sheet product manufactured according to this invention, the 4xxx-series aluminium alloy brazing layer(s) can be bonded in various manners, for example by roll bonding via hot rolling as is well-known and most used in the art or by casting together the core and brazing layer, for example by the manufacturing process disclosed in WO-2004/112992 or partially or completely fabricated via a casting process according to U.S. Pat. No. 6,705,384.

In an embodiment, the brazing sheet product manufactured in accordance with the invention has a core layer of a 3xxx-series aluminium alloy as herein described and claimed and being clad on one or both sides with a 4xxx-series aluminium alloy brazing layer is devoid of any intermediate aluminium alloy layer, e.g. a lxxx-, 3xxx, or 5xxx-series alloy, positioned between the core layer and the brazing layer.

In another aspect of the invention it has been found that the method can also be successfully applied for manufacturing a brazing sheet product having a core layer of a 6xxx-series aluminium alloy clad on one or both sides with a 4xxx-series aluminium alloy brazing layer, and achieving similar improvements in resistance against LFM and increased formability, and wherein the 6xxx-series aluminium alloy has a composition, in wt. %,

| | |
|---|---|
| Si | 0.2% to 1.2%, |
| Mg | 0.3% to 1.2%, |
| Cu | up to 0.4%, preferably up to 0.2%, |
| Fe | up to 0.6%, preferably 0.05% to 0.5%, |
| Mn | up to 0.4%, preferably up to 0.2%, |
| Zr | up to 0.2%, preferably up to 0.05%, |
| Cr | up to 0.2%, preferably up to 0.10%, |
| Ti | up to 0.2%, |
| Zn | up to 0.5%, preferably up to 0.25%, |

other elements and impurities each <0.05%, total <0.15, and balance aluminium.

Preferred 6xxx-series aluminium alloys within this compositional range are AA6060, AA6160, AA6063, and AA6063A.

The invention further relates to a brazed heat exchanger device incorporating a component made from the brazing sheet product manufactured in accordance with this invention. The brazing sheet product can be employed amongst others in a CAB process and by means of vacuum brazing. A particular component is a tube or a plate of such a brazed heat exchanger device. In a preferred embodiment the heat exchanger device is a stacked plate heat exchanger, such as an oil cooler or an evaporator with plate designs or a charge air cooler, or a chiller for battery cooling. For these types of application typically aluminium brazing sheet in a gauge range of about 0.25 to 0.9 mm are being used and which are in practice heavily formed and/or deep-drawn prior to assembly. In particular in these kinds of application the advantages of the brazing sheet product obtained by the method in accordance with this invention are noticeable and appreciated.

Furthermore, the invention relates to the use or to a method of use of the brazing sheet product obtained by the method in accordance with this invention in a heat exchanger device, in particular a stacked plate heat exchanger.

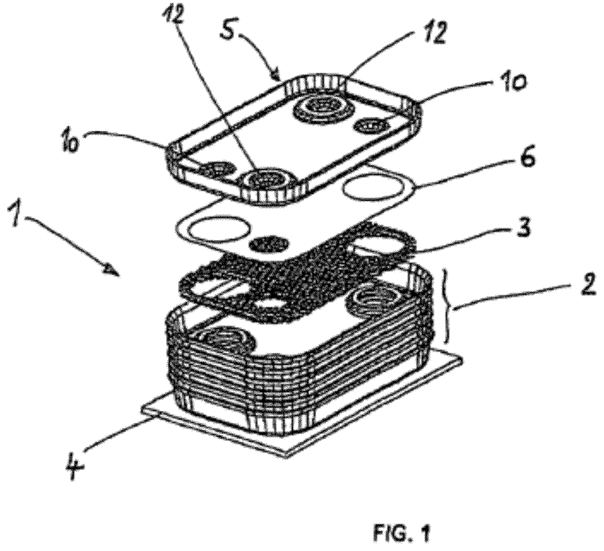

The invention shall also be described with reference to the appended FIG. 1 showing a drawing of the construction of a stacked plate oil cooler in a partially exploded illustration.

FIG. 1 shows schematically an example of the construction of a stacked plate oil cooler 1 which is constructed from a multiplicity of stacking plates 2 and metal turbulence plates 3 (turbulence inserts) arranged between said stacking plates 2. The stacked plate oil cooler 1 is closed off by means of a base plate 4 and a cover plate 5. An intermediate metal plate 6 is inserted between the uppermost metal turbulence plate 3 and the cover plate 5. Connections for the oil and a liquid coolant are arranged in the relative thick base plate 4 but cannot be seen or are not illustrated in this FIG. 1. In contrast, the cover plate 5 is closed; it has, in this embodiment, stamped impressions 10, 12. In this example in particular the stacking plates 2 can be made of the brazing sheet products manufactured by the method according to the invention.

The invention will now be illustrated with reference to non-limiting examples according to the invention.

### Example

On an industrial scale of manufacturing a 3xxx-series aluminium core alloy has been DC-cast with the following composition, in wt. %, 1.05% Mn, 0.45% Cu, 0.25% Mg, 0.20% Fe, 0.09% Ti, 0.06% Si, 0.1% Zn, balance aluminium and inevitable impurities.

As is regular in the art, via roll bonding the core alloy has been clad on both sides with a 4xxx-series brazing filler alloy layer having a composition, in wt. %, of 9.9% Si, 0.7% Mg, 0.2% Fe, 0.06% Zn, 0.07% Bi, 0.02% Cu, balance aluminium and inevitable impurities. Each filler alloy brazing layer has a 10% thickness of the total brazing sheet thickness.

The brazing sheet package has been hot rolled and cold rolled to 0.39 mm and soft annealed at 370° C. for 2 hours (Condition 1).

Next the soft annealed cold rolled brazing sheet product has been cold rolled by about 7.7% reduction to a final gauge of 0.36 mm (Condition 2) and subsequently recovery annealed at 370° C. for 3 hours (Condition 3).

Brazing sheet products of Condition 1, 2 and 3 were given a simulated “slight cold work” treatment, as in common in the art and known to the skilled person, by stretching of about 4% using a standard tensile testing equipment to simulate the deformation resulting from industrial processes such as stamping and roll forming to produce components of heat exchangers. The core penetration depths (LFM) of the 4% stretched brazing sheet products were measured using standard metallography on metallographic sections after utilizing a simulated inert gas atmosphere braze cycle by soaking for 3 minutes at 600° C.

The brazing sheet product in Condition 1 had a core penetration depth of about 40 micron, whereas in Condition 2 and Condition 3 the core penetration depth was about 23 micron.

For each condition, using the applicable industry standard DIN EN ISO 6892-1:2017-02, the elongation (A50) has been measured in the L-direction. As an average over three measurements:

Condition 1: 14.9%

Condition 2: 9.0%

Condition 3: 15.1%

And in Condition 2 in the L-direction the measured Rp0.2 was 148 MPa and the Rm was 156 MPa, and in Condition 3 the measured Rp0.2 was 84 MPa and the Rm was 152 MPa.

From these experiments it can be seen that in an O-temper condition the brazing sheet product has a very good formability when expressed in A50 elongation but in combination with a very poor resistance to LFM. This resistance to LFM can be significantly improved by applying a further cold rolling reduction in a range of 5% to <10%. However, this increased resistance to LFM is associated with a reduction in formability, low elongation and high Rp0.2. However, the combination of a cold rolling reduction in a range of 5% to <10% and a recovery final annealing offers a favourable increased resistance to LFM and a formability comparable or even better than O-temper material.

In a further series of testing on the same brazing sheet material a process has been applied closely related to Condition 3 but with a recovery annealing at a lower temperature of about 300° C. for about 3 hours. It has been found that for the same alloy combination the core penetration depth was further reduced to less than 17 micron, while having a similar formability performance.

This renders the brazing sheet products manufactured in accordance with the invention suitable for use in heat exchangers, in particular for manufacturing components for stacked plate heat exchangers.

The invention is not limited to the embodiments described before, and which may be varied widely within the scope of the invention as defined by the appending claims.

1. A method of manufacturing a brazing sheet product having a core layer of a 3xxx-series aluminium alloy clad on one or both sides with a 4xxx-series aluminium alloy brazing layer, the method comprising the steps of:
(a) casting a rolling ingot of the core layer of a 3xxx-series aluminium alloy having the following composition, in wt. %:

| | |
|---|---|
| Mn | 0.5 to 1.8, |
| Si | up to 1.5, |
| Fe | up to 0.7, |
| Cu | up to 1.5, |
| Mg | up to 1.0, |
| Cr | up to 0.25, |
| Zr | up to 0.25, |
| Ti | up to 0.25, |
| Zn | up to 0.5, |

other elements and impurities each <0.05, total <0.15; balance aluminium.
(b) hot rolling of the rolling ingot to a hot rolled sheet having thickness of 2.5 to 10 mm;
(c) cold rolling of the hot rolled sheet to a gauge of 0.1 to 4 mm;
(d) soft annealing to recrystallize the microstructure of the aluminium sheet;
(e) further cold rolling of the soft annealed sheet with a cold rolling reduction in the range of 5% to <10% to a final cold rolling thickness; and
(f) recovery annealing of the cold rolled aluminium sheet at final cold rolling thickness, wherein the recovery annealing is performed at a temperature in the range of 200° C. to 420° C.

2. The method according to claim 1, wherein the recovery annealing during step (f) is performed at a temperature in the range of 200° C. to 400° C.

3. The method according to claim 1, wherein the recovery annealing during step (f) is to an elongation of more than 10% in the brazing sheet product.

4. The method according to claim 1, wherein an intermediate annealing step is performed during the cold rolling operation and wherein the intermediate annealing during the cold rolling operation of step (c) is at a temperature in the range of 200° C. to 450° C.

5. The method according to claim 1, the 3xxx-series aluminium alloy has a Mg-content in the range of up to 0.7%.

6. The method according to claim 1, wherein the final cold rolling thickness during step (e) is to a thickness in the range of 0.1 mm to 3 mm.

7. The method according to claim 1, wherein the 3xxx-series aluminium alloy has a Mn-content in the range of 0.6% to 1.5%.

8. The method according to claim 1, wherein the 3xxx-series aluminium alloy has a Si-content in the range of up to 0.9%.

9. The method according to claim 1, wherein the 3xxx-series aluminium alloy has a Cu-content in the range of up to 1.2%.

10. The method according to claim 1, wherein the 3xxx-series aluminium alloy has a Cu-content in the range of up to 0.25.

11. The method according to claim 1, wherein the 3xxx-series aluminium sheet is clad on one or both sides with a 4xxx-series aluminium alloy brazing layer with each brazing layer having a thickness of 4% to 20% of the total brazing sheet thickness.

12. The method according to claim 1, wherein the brazing sheet product having a core layer of a 3xxx-series aluminium alloy clad on one or both sides with a 4xxx-series aluminium alloy brazing layer is devoid of any intermediate aluminium alloy layer positioned between the core layer and the brazing layer.

13. Heat exchanger incorporating a tube or plate made from the aluminium sheet manufactured according to claim 1.

14. The heat exchanger according to claim 13, wherein the heat exchanger is a stacked plate heat exchanger.

15. Use of an aluminium alloy brazing sheet product having a 3xxx-series aluminium alloy core layer manufactured according to claim 1 in a heat exchanger.

16. The method of claim 1, wherein the soft annealing is performed at a temperature in the range of 250° C. to 450° C.

17. The method of claim 2, wherein the recovery annealing during step (f) is performed at a temperature in the range of 250° C. to 380° C.

18. The method of claim 3, wherein the recovery annealing during step (f) is to an elongation of more than 14%.

19. The method of claim 5, wherein the Mg-content is in the range of 0.1% to 0.7%.

20. The method of claim 7, wherein the Mn-content is in the range of 0.6% to 1.25%.
